(19) United States
(12) Patent Application Publication
(10) Pub. No.: US 2018/0211302 A1
(43) Pub. Date: Jul. 26, 2018

(54) SYSTEMS AND METHODS FOR CATEGORIZING PRODUCTS FOR A WEBSITE OF AN ONLINE RETAILER

(71) Applicant: WAL-MART STORES, INC., Bentonville, AR (US)

(72) Inventors: Abhinandan Krishnan, Sunnyvale, CA (US); Jonathan Tan, Sunnyvale, CA (US); Jianhui Zhang, Milpitas, CA (US)

(73) Assignee: WAL-MART STORES, INC., Bentonville, AR (US)

(21) Appl. No.: 15/413,871

(22) Filed: Jan. 24, 2017

(51) Int. Cl. G06Q 30/06; G06N 99/00

(52) U.S. Cl. CPC G06Q 30/0623; G06N 99/005; G06Q 30/0613

(57) ABSTRACT

Systems and methods including one or more processing modules and one or more non-transitory storage modules storing computing instructions configured to run on the one or more processing modules and perform acts of selecting a plurality of products of an online retailer, receiving first manual categorizations of the plurality of products from a plurality of users, preparing a machine learning model for automatically categorizing additional products based on the first manual categorizations of the plurality of products, receiving a product description for an additional product, automatically categorizing the additional product into one or more categories for display on a webpage of the online retailer based on the product description of the first additional product using the machine learning model, and coordinating the display of the webpage of the online retailer of the additional product.

### TECHNICAL FIELD

This disclosure relates generally to categorizing products for a website of an online retailer.

### BACKGROUND

Online retailers regularly receive product information for new products to display on webpages of the online retailer. Categorizing the new product on the website can be difficult, particularly if the website includes numerous pre-established categories that do not exactly match the new products.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 5;

FIG. 2 illustrates a representative block diagram of an example of the elements included in the circuit boards inside a chassis of the computer system of FIG. 1;

FIG. 3 illustrates a representative block diagram of a system, according to an embodiment;

FIGS. 4A-C are flowcharts for a method, according to certain embodiments; and

FIG. 5 illustrates a representative block diagram of a portion of the system of FIG. 3, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processing modules and one or more non-transitory storage modules storing computing instructions configured to run on the one or more processing modules. The one or more storage modules can be configured to run on the one or more processing modules and perform the act of selecting a plurality of products of an online retailer. The one or more storage modules can be further configured to run on the one or more processing modules and perform the act of coordinating a first display on electronic devices of a plurality of users of the plurality of products for manual categorization by the plurality of users. The one or more storage modules can be further configured to run on the one or more processing modules and perform the act of receiving first manual categorizations of the plurality of products from the plurality of users. The one or more storage modules can be further configured to run on the one or more processing modules and perform the act of preparing a machine learning model for automatically categorizing additional products using the one or more processing modules and based on the first manual categorizations of the plurality of products by the plurality of users. The one or more storage modules can be further configured to run on the one or more processing modules and perform the act of receiving a product description for a first additional product for a second display of a first webpage of the online retailer. The one or more storage modules can be further configured to run on the one or more processing modules and perform the act of automatically categorizing the first additional product into one or more categories for the second display of the first webpage of the online retailer based on the product description of the first additional product using the machine learning model and the one or more processing modules. The one or more storage modules can be further configured to run on the one or more processing modules and perform the act of coordinating the second display of the first webpage of the online retailer of the first additional product according to the one or more categories of the first additional product as automatically categorized by the one or more processing modules using the machine learning model.

Various embodiments include a method. The method can include selecting a plurality of products of an online retailer. The method also can include coordinating a first display on electronic devices of a plurality of users of the plurality of products for manual categorization by the plurality of users. The method also can include receiving first manual categorizations of the plurality of products from the plurality of users. The method also can include preparing a machine learning model for automatically categorizing additional products using one or more processing modules and based on the first manual categorizations of the plurality of products by the plurality of users. The method also can include receiving a product description for a first additional product for a second display of a first webpage of the online retailer. The method also can include automatically categorizing the first additional product into one or more categories for the second display of the first webpage of the online retailer based on the product description of the first additional product using the machine learning model and the one or more processing modules. The method also can include coordinating the second display of the first webpage of the online retailer of the first additional product according to the one or more categories of the first additional product as automatically categorized by the one or more processing modules using the machine learning model.

A number of embodiments can include a system. The system can include one or more processing modules and one or more non-transitory storage modules storing computing instructions configured to run on the one or more processing modules. The one or more storage modules can be configured to run on the one or more processing modules and perform an act of selecting a plurality of products of an online retailer. The one or more storage modules can be further configured to run on the one or more processing modules and perform an act of coordinating a first display on electronic devices of a plurality of users of the plurality of products for first manual categorizations by the plurality of users. The one or more storage modules can be further configured to run on the one or more processing modules and perform an act of receiving the first manual categorizations of the plurality of products from the plurality of users. The one or more storage modules can be further configured to run on the one or more processing modules and perform an act of preparing, with the one or more processing modules, a plurality of categorization rules based on the first manual categorizations of the plurality of products by the plurality of users. The one or more storage modules can be further configured to run on the one or more processing modules and perform an act of automatically categorizing, with the one or more processing modules, a first additional product using at least one of the plurality of categorization rules. The one or more storage modules can be further configured to run on the one or more processing modules and perform an act of coordinating a second display of a first webpage of the online retailer of the first additional product as automatically categorized by the one or more processing modules according to the plurality of categorization rules.

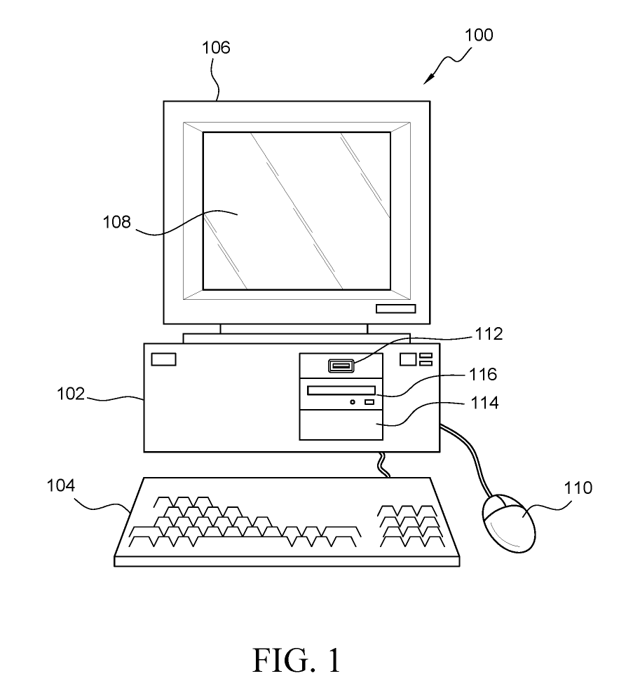

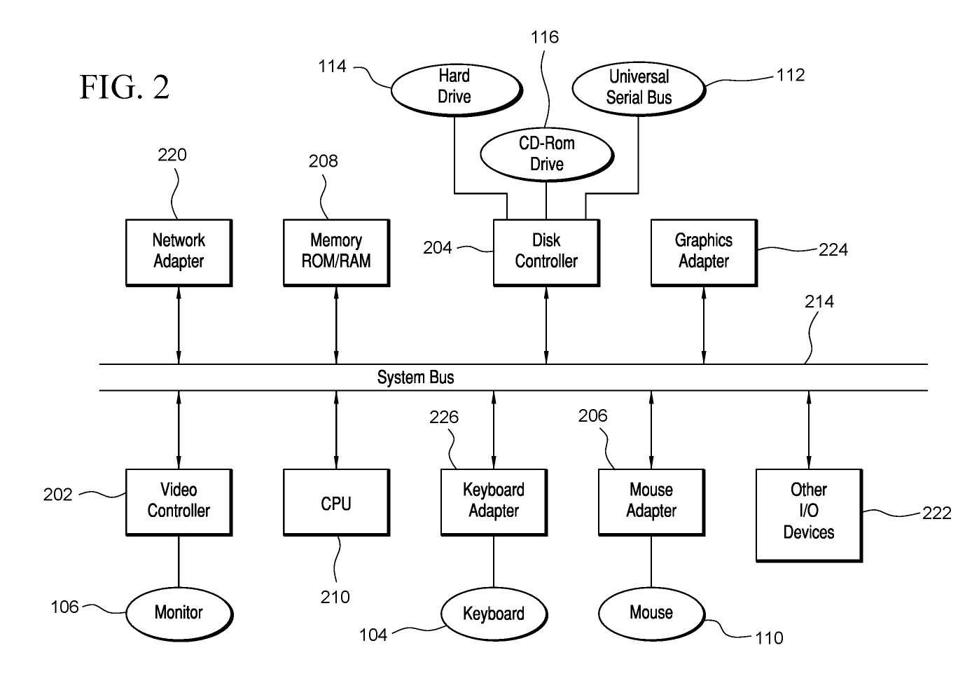

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), a CD-ROM and/or DVD for use with CD-ROM and/or DVD drive 116 (FIGS. 1-2), a floppy disk for use with a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

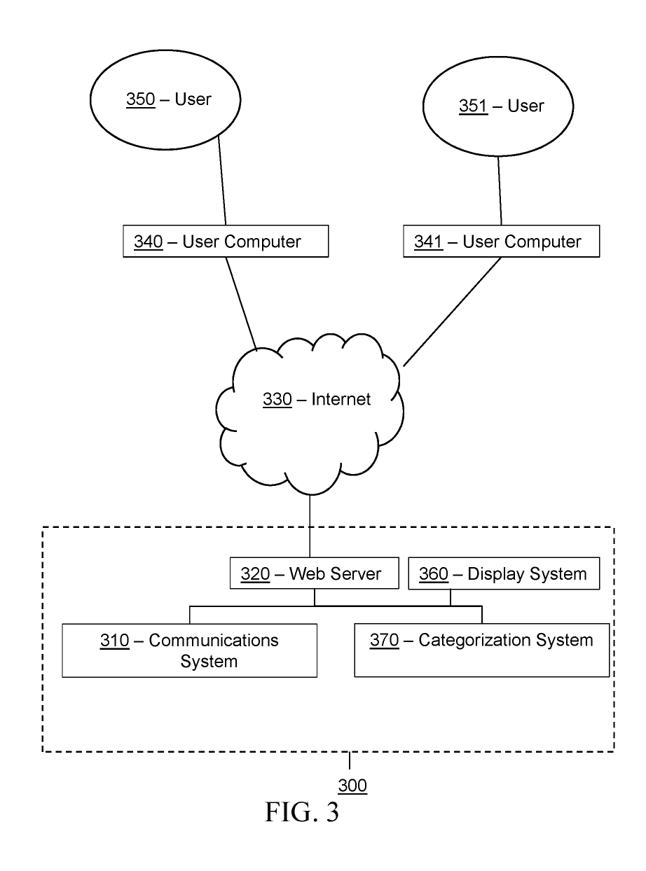

Turning ahead in the drawings, FIG. 3 illustrates a block diagram of a system 300 that can be employed for categorizing products of an online retailer as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include a communication system 310, a web server 320, a display system 360, and/or a categorization system 370. Communication system 310, web server 320, display system 360, and/or categorization system 370 can each be a computer system, such as computer system 100 (FIG. 1), as described above, and can each be a single computer, a single server, or a cluster or collection of computers or servers, or a cloud of computers or servers. In another embodiment, a single computer system can host each of two or more of communication system 310, web server 320, display system 360, and/or categorization system 370, as described herein.

In many embodiments, system 300 also can comprise user computers 340, 341. In some embodiments, user computers 340, 341 can be a mobile device. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through Internet 330 with user computers (e.g., 340, 341). In certain embodiments, user computers 340-341 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, communication system 310, web server 320, display system 360, and/or categorization system 370 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) communication system 310, web server 320, display system 360, and/or categorization system 370 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of communication system 310, web server 320, display system 360, and/or categorization system 370. In a similar manner, the processing module(s) and the memory storage module(s) can be local and/or remote to each other.

In many embodiments, communication system 310, web server 320, display system 360, and/or categorization system 370 can be configured to communicate with one or more user computers 340 and 341. In some embodiments, user computers 340 and 341 also can be referred to as customer computers. In some embodiments, communication system 310, web server 320, display system 360, and/or categorization system 370 can communicate or interface (e.g., interact) with one or more customer computers (such as user computers 340 and 341) through a network or internet 330. Internet 330 can be an intranet that is not open to the public. Accordingly, in many embodiments, communication system 310, web server 320, display system 360, and/or categorization system 370 (and/or the software used by such systems) can refer to a back end of system 300 operated by an operator and/or administrator of system 300, and user computers 340 and 341 (and/or the software used by such systems) can refer to a front end of system 300 used by one or more users 350 and 351, respectively. In some embodiments, users 350 and 351 also can be referred to as customers, in which case user computers 340 and 341 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, communication system 310, web server 320, display system 360, and/or categorization system 370 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between communication system 310, web server 320, display system 360, and/or categorization system 370, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

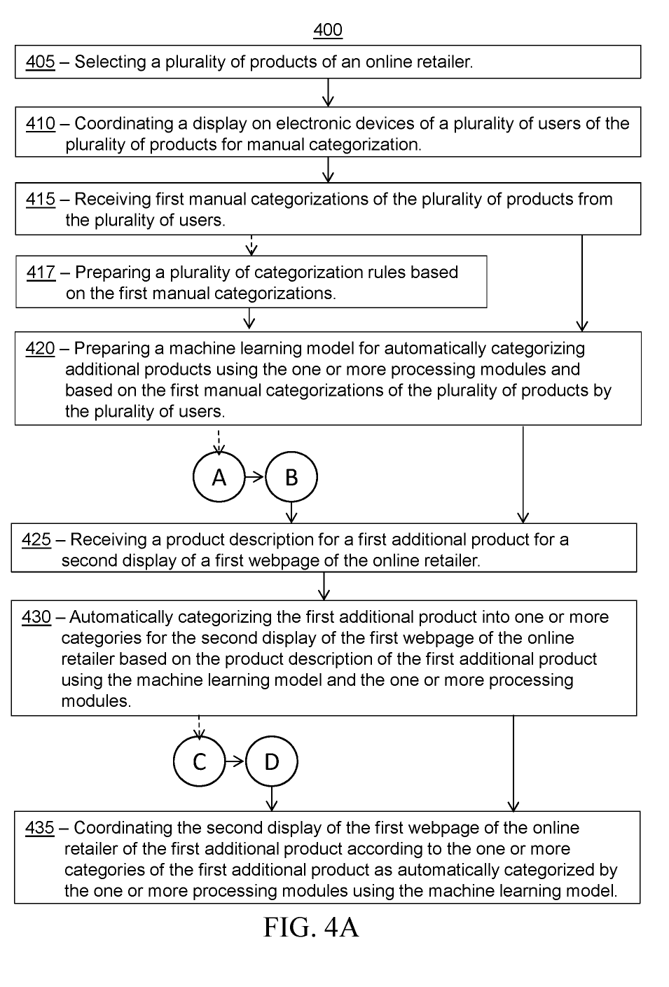

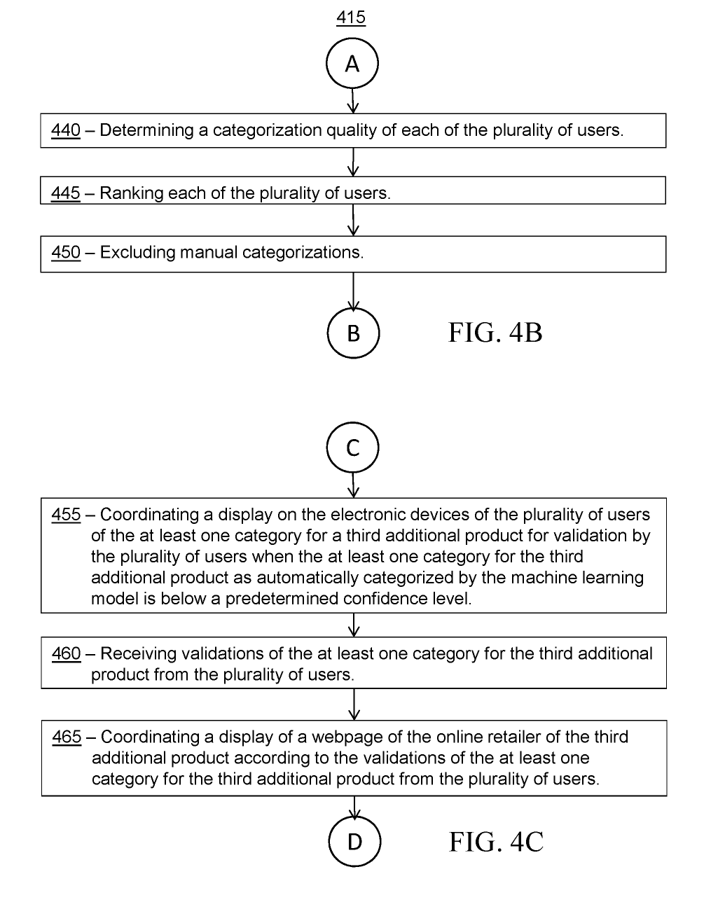

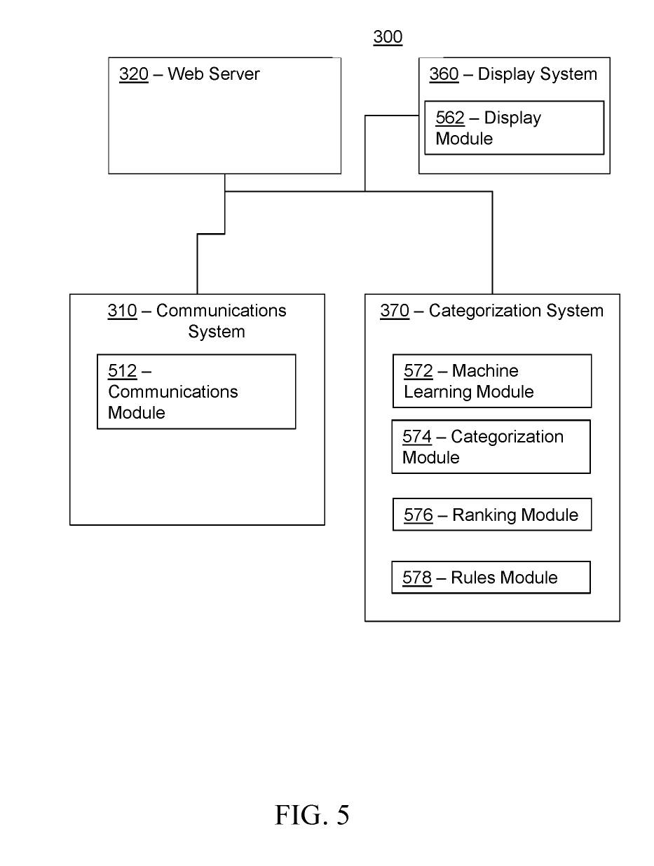

Turning ahead in the drawings, FIGS. 4A-C illustrate a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules 512, 562, 572, 574, 576, and/or 578 (FIG. 5). Such non-transitory memory storage modules can be part of a computer system such as communication system 310, web server 320, display system 360, and/or categorization system 370 (FIGS. 3 & 5). The processing module(s) can be similar or identical to the processing module(s) described above with respect to computer system 100 (FIG. 1).

Online retailers regularly receive product information for new products to display on webpages of the online retailer. Categorizing the new product on the website can be difficult, particularly if the website includes numerous pre-established categories that do not accurately describe or fit the new products. To overcome this problem of categorizing new or additional products for a web site of an online retailer, systems and methods of categorizing products are described herein. In some embodiments, the systems and methods described herein can categorize new products according to preexisting categories on a website of the online retailer, thus providing an improved customer experience. Moreover, in some embodiments, machine learning models that can include natural language processing can be used to automatically categorize additional products.

Turning to FIG. 4A, method 400 can comprise an activity 405 of selecting a plurality of products of an online retailer. In some embodiments, the plurality of products is available only on a website of the online retailer. In some embodiments, individual products of the plurality of products are available only for pick up at a physical brick and mortar store after ordering the individual products on the website of the online retailer. In still other embodiments, the plurality of products are available both on the website of the online retailer and also at the physical brick and mortar store of the online retailer. The plurality of products can comprise any of a number of products in a catalog of the online retailer. In some embodiments, the plurality of products selected pertains to a wide variety of unrelated categories. In other embodiments, the plurality of products selected pertains to one or more related categories.

Method 400 can further comprise an activity 410 of coordinating a display on electronic devices of a plurality of users of the plurality of products for manual categorization. In some embodiments, the plurality of users can comprise a plurality of internal users and one or more third party users. For example, the plurality of internal users can comprise employees of the online retailer, and the one or more third party users can comprise one or more external users who are not employees of the online retailer. In some embodiments, the one or more external users can comprise public users who volunteer to manually categorize one or more products of the plurality of products. In other embodiments, the one or more external users can comprise a group or organization solicited by the online retailer to manually categorize one or more products of the plurality of products. Any of the one or more external users can comprise customers of the online retailer. The plurality of users can be referred to as a crowd for crowdsourcing categorization or classification of the plurality of products.

In some embodiments, the plurality of products can be coordinated for display on software downloadable on electronic devices of the plurality of users. The software can be configured to allow a user to view a product of the plurality of products and/or read a product description associated with the product of the plurality of products, and categorize or otherwise classify the product of the plurality of products. A plurality of product categories can be displayed for the user to choose from or, alternatively, the user may enter a category without any potential categories being displayed to the user. In some embodiments, system 300 (FIG. 3) is configured to allow a user, such as an internal user, to correct a miscategorization of a product found by the user. Categories can comprise any product categories typically used on a website of an online retailer, such as but not limited to departments, brands, sizes, models, colors, and the like.

Method 400 can further comprise an activity 415 of receiving first manual categorizations of the plurality of products from the plurality of users. In some embodiments, one or more users can manually enter categorizations of the plurality of products on the electronic device(s) of the one or more users. As noted above, in some embodiments, a user can select from potential categories, while in other embodiments, a user enters one or more categories for a product of the plurality of products without being given any potential categories from which to choose. As an example, the one or more users can be one or more employees of the online retailer, or one or more suppliers of the online retailer who provided the plurality of products to the online retailer. The manual categorizations of the plurality of products can then be transmitted to the system 300 (FIG. 3) of the online retailer.

Method 400 optionally can further comprise an activity 417 of preparing a plurality of categorization rules based on the first manual categorizations. In some embodiments, activity 417 can comprise preparing, with one or more processing modules, a plurality of categorization rules based on the first manual categorizations of the plurality of products by the plurality of users. For example, based on a plurality of users categorizing as books certain products with product descriptions that include an International Standard Book Number (ISBN), a rule can be created that, if a product description associated with a product contains an ISBN, the product should be categorized as a book.

After activity 417, method 400 optionally can further comprise an activity of automatically categorizing, with the one or more processing modules, an additional product using at least one of the plurality of categorization rules. For example, if the online retailer receives a new product with a product that includes an ISBN, system 300 (FIG. 3) can automatically categorize the product as a book based on the categorization rule that was created as described above. Method 400 optionally can further comprise coordinating a display of a webpage of the online retailer of the additional product or new product as automatically categorized by the one or more processing modules according to the plurality of categorization rules.

Continuing with FIG. 4A, method 400 can further comprise an activity 420 of preparing a machine learning model for automatically categorizing additional products using the one or more processing modules and based on the first manual categorizations of the plurality of products by the plurality of users. In some embodiments, the machine learning model is configured to use the knowledge collected from the first manual categorizations of the plurality of products to categorize a new product that is sent to the online retailer. For example, if a new telephone is sent to the online retailer that is similar to a previously categorized telephone, the machine learning model can determine if the product information for the new telephone is close enough to data in the system 300 (FIG. 3) that is based on the previously categorized telephone to allow the machine learning model to categorize the new telephone. In some embodiments, the machine learning model can use a natural language processor to understand a product description of a new additional product and apply the manual categorization by the plurality of users to the new additional product. In some embodiments, the machine learning model can comprise a hierarchical-based machine learning model.

Turning ahead in the drawings to FIG. 4B, method 400 optionally can further comprise an activity 440 of determining a categorization quality of each of the plurality of users. Determining a categorization quality of each of the plurality of users allows system 300 to evaluate the plurality of users and determine whether or not their respective categorizations are trustworthy. In some embodiments, each user of the plurality of users is evaluated relative to a domain expert. A domain expert can comprise a special editor who has domain knowledge in the field of the particular product. A domain expert can be considered the absolute truth for categorization of a product. In some embodiments, one or more domain experts are solicited by the online retailer to assist in evaluation of the plurality of users.

In some embodiments, activity 440 can comprise determining a categorization quality of each of the plurality of internal users and the one or more third party users by comparing one or more manual categorizations of the plurality of products made by each of the plurality of internal users and the one or more third party users to one or more manual categorizations of the plurality of products made by a domain expert. In more particular embodiments, categorization quality of each user of the plurality of users can be specific to particular product attributes. For example, a user can be evaluated for categorization quality for color attributes, size attributes, etc. Some users can be determined to be more trustworthy for certain product attributes, while also determined to be less trustworthy for other certain product attributes. Thus, activity 440 also can comprise determining the categorization quality of each of the plurality of internal users and the one or more third party users by a plurality of attributes of the plurality of products by comparing the one or more manual categorizations of the plurality of products made by each of the plurality of internal users and the one or more third party users to the one or more manual categorizations of the plurality of products made by a domain expert.

Method 400 optionally can further comprise an activity 445 of ranking each of the plurality of users. In some embodiments, the plurality of users can be ranked by their respective categorization quality as evaluated. Thus, the plurality of users can be ranked differently according to a level of trustworthiness or expertise for each particular user. As noted above, the level of trustworthiness can be specific to certain product attributes.

In some embodiments, activity 445 can comprise ranking each of the plurality of internal users and the one or more third party users into rankings by the categorization quality of each of the plurality of internal users and the one or more third party users. Each third party user of the one or more third party users can be ranked as an individual user in the rankings, and each user of the plurality of internal users is ranked as a different individual user in the rankings. For example, if the online retailer solicits a third party user to categorize the product and that third party user then uses a plurality of other individual users to categorize the product, only the third party as a whole can be evaluated and ranked as one user. In some embodiments, the plurality of internal users can be ranked automatically higher than the one or more third party users.

In some embodiments, ranking each of the plurality of internal users and the one or more third party users in activity 445 can comprise ranking each of the plurality of internal users and the one or more third party users by the categorization quality of the plurality of attributes of the plurality of products of each of the plurality of internal users and the one or more third party users. Each user of the plurality of users can be ranked specifically for different product attributes. Thus, a user can comprise a high ranking for categorization of a first product attribute, and a low ranking for categorization of a second product attribute.

In some embodiments, rankings can be used in determining which user of a plurality of users should be trusted for categorization of a new additional product. For example, method 400 optionally can comprise an activity of coordinating a display on the electronic devices of the plurality of users of an additional product for additional or second manual categorizations by the plurality of users. Method 400 optionally can comprise an activity of receiving the additional or second manual categorizations of the additional product from the plurality of users.

Method 400 optionally can further comprise automatically categorizing the additional product according to the additional or second manual categorizations of the additional product by one or more higher ranked users of the plurality of internal users and the one or more third party users when the second manual categorizations of the additional product by the one or more higher ranked users of the plurality of internal users and the one or more third party users conflicts with the second manual categorizations of the additional product by one or more lower ranked users of the plurality of internal users and the one or more third party users. The one or more lower ranked users can be ranked lower than the one or more higher ranked users according to the categorization quality of each of the plurality of internal users and the one or more third party users. Method 400 can further comprise an activity of coordinating a display of the additional product on a second webpage of the online retailer as manually categorized by the one or more higher ranked users. In some embodiments, second webpage is very different from a first webpage (described below) where the additional product has not been categorized according to rankings of the plurality of users. In other embodiments, the second webpage is similar to the first webpage, except for the addition of the additional product on the second webpage.

Continuing with FIG. 4B, method 400 can further optionally comprise an activity 450 of excluding manual categorizations. In some embodiments, activity 450 can comprise excluding the first manual categorizations by at least one of the plurality of internal users or the one or more third party users from data used to create the machine learning model if the at least one of the plurality of internal users or the one or more third party users does not meet a predetermined ranking requirement. In more particular embodiments, manual categorizations can be excluded based on rankings of the user for categorization quality of one or more product attributes. For example, activity 450 can comprise excluding the first manual categorizations by the at least one of the plurality of internal users or the one or more third party users from the data used to create the machine learning model for one or more attributes of the first additional product when the at least one of the plurality of internal users or the one or more third party users does not meet a predetermined ranking requirement for categorizing the plurality of products according to one or more attributes of the plurality of attributes of the plurality of products corresponding to the one or more attributes of the first additional product. In some embodiments, the at least one of the plurality of internal users or the one or more third party users do not know that their manual rankings are excluded, and in other embodiments, the system or online retailer notifies the at least one of the plurality of internal users or the one or more third party users that their rankings will be excluded if their accuracy does not improve and/or that their rankings have been excluded due to their inaccuracy.

Returning to FIG. 4A, method 400 can further comprise an activity 425 of receiving a product description for a first additional product for a display of a first webpage of the online retailer. The product information can comprise natural language describing the product, product specifications and details, and the like. The product information can be received from a vendor or distributor of the first additional product. Method 400 can further comprise an activity 430 of automatically categorizing the first additional product into one or more categories for the display of the first webpage of the online retailer based on the product description of the first additional product using the machine learning model and the one or more processing modules.

Turning ahead in the drawings to FIG. 4C, method 400 optionally can further comprise an activity 455 of coordinating a display on the electronic devices of the plurality of users of the at least one category for an additional product for validation by the plurality of users when the at least one category for the additional product as automatically categorized by the machine learning model is below a predetermined confidence level. For example, a confidence level in the categorization by the machine learning model can be provided each time the machine learning model categorizes an additional product. If the confidence level is below a predetermined confidence level, validation of the results may be necessary. Thus, system 300 (FIG. 3) can coordinate a display on the electronic devices of the plurality of users of the at least one category for an additional product for validation by the plurality of users. In some embodiments, the at least one category coordinated for display can comprise a plurality of categories, such as but not limited to the top categories as determined by system 300. In some embodiments, the at least one category is coordinated for display only on the devices of users of the plurality of users who have been evaluated to satisfy a predetermined ranking or level of trustworthiness, as described in greater detail above.

Method 400 optionally can further comprise an activity 460 of receiving validations of the at least one category for the additional product from the plurality of users. In some embodiments, the validations of the at least one category can be used to retrain the machine learning model. Method 400 optionally can further comprise an activity 465 of coordinating a display of a webpage of the online retailer of the additional product according to the validations of the at least one category for the third additional product from the plurality of users.

Returning to FIG. 4A, method 400 can further comprise an activity 435 of coordinating the display of the first webpage of the online retailer of the first additional product according to the one or more categories of the additional product as automatically categorized by the one or more processing modules using the machine learning model.

In some embodiments, categorization of one or more additional products can be prioritized. For example, in some embodiments, an additional product can first be attempted to be categorized by one or more internal users. If categorization by the one or more internal users is unsuccessful, the additional product can next be attempted to be categorized by one or more external users. If categorization by the one or more external users is unsuccessful, the additional product can next be attempted to be categorized by one or more categorization rules based on manual categorizations. If categorization by the one or more categorization rules is unsuccessful, the additional product can next be attempted to be categorized by the machine learning model based on the manual categorizations. Thus, in some embodiments, an additional product can be categorized by the plurality of users, the categorization rules, and/or the machine learning model before the system coordinates a display of the additional product on a webpage of the online retailer. In some embodiments, additional products can be categorized by only one of the plurality of users, the categorization rules, and/or the machine learning model. In other embodiments, additional products can be attempted to be categorized by more than one of the plurality of users, the categorization rules, and/or the machine learning model.

FIG. 5 illustrates a block diagram of a portion of system 300 comprising communication system 310, web server 320, display system 360, and categorization system 370, according to the embodiment shown in FIG. 3. Each of communication system 310, web server 320, display system 360, and categorization system 370, is merely exemplary and not limited to the embodiments presented herein. Each of communication system 310, web server 320, display system 360, and/or categorization system 370, can be employed in many different embodiments or examples not specifically depicted or described herein. In some embodiments, certain elements or modules of communication system 310, web server 320, display system 360, and/or categorization system 370, can perform various procedures, processes, and/or acts. In other embodiments, the procedures, processes, and/or acts can be performed by other suitable elements or modules.

In many embodiments, communications system 310 can comprise non-transitory memory storage module 512. Memory storage module 512 can be referred to as communications module 512. In many embodiments, communications module 512 can store computing instructions configured to run on one or more processing modules and perform one or more acts of method 400 (FIGS. 4A-C) (e.g., activity 415 of receiving first manual categorizations of the plurality of products from the plurality of users (FIG. 4A), activity 425 of receiving a product description for a first additional product for a second display of a first webpage of the online retailer (FIG. 4A), and activity 460 of receiving validations of the at least one category for the third additional product from the plurality of users (FIG. 4C)).

In many embodiments, display system 360 can comprise non-transitory memory storage module 562. Memory storage module 562 can be referred to as display module 562. In many embodiments, display module 562 can store computing instructions configured to run on one or more processing modules and perform one or more acts of method 400 (FIGS. 4A-C) (e.g., activity 410 of coordinating a first display on electronic devices of a plurality of users of the plurality of products for manual categorization (FIG. 4A), activity 435 of coordinating the second display of the first webpage of the online retailer of the first additional product according to the one or more categories of the first additional product as automatically categorized by the one or more processing modules using the machine learning model (FIG. 4A), activity 455 of coordinating a display on the electronic devices of the plurality of users of the at least one category for a third additional product for validation by the plurality of users when the at least one category for the third additional product as automatically categorized by the machine learning model is below a predetermined confidence level (FIG. 4C), and activity 465 of coordinating a display of a webpage of the online retailer of the third additional product according to the validations of the at least one category for the third additional product from the plurality of users (FIG. 4C)).

In many embodiments, categorization system 370 can comprise non-transitory memory storage modules 572, 574, 576, and 578. Memory storage module 572 can be referred to as machine learning module 572, memory storage module 574 can be referred to as categorization module 574, memory storage module 576 can be referred to ranking module 576, and memory storage module 578 can be referred to as rule module 578. In many embodiments, machine learning module 572 can store computing instructions configured to run on one or more processing modules and perform one or more acts of method 400 (FIGS. 4A-C) (e.g., activity 420 of preparing a machine learning model for automatically categorizing additional products using the one or more processing modules and based on the first manual categorizations of the plurality of products by the plurality of users (FIG. 4A), and activity 450 of excluding manual categorizations (FIG. 4B)).

In many embodiments, categorization module 574 can store computing instructions configured to run on one or more processing modules and perform one or more acts of method 400 (FIGS. 4A-C) (e.g., activity 405 of selecting a plurality of products of an online retailer (FIG. 4A), and activity 430 of automatically categorizing the first additional product into one or more categories for the second display of the first webpage of the online retailer based on the product description of the first additional product using the machine learning model and the one or more processing modules (FIG. 4A)). In many embodiments, ranking module 576 can store computing instructions configured to run on one or more processing modules and perform one or more acts of method 400 (FIGS. 4A-C) (e.g., activity 440 of determining a categorization quality of each of the plurality of users (FIG. 4B), and activity 445 of ranking each of the plurality of users (FIG. 4B)). In many embodiments, rules module 578 can store computing instructions configured to run on one or more processing modules and perform one or more acts of method 400 (FIGS. 4A-C) (e.g., activity 417 of preparing a plurality of categorization rules based on the first manual categorizations).

Although categorizing products of an online retailer has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIGS. 4A-C may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
selecting a plurality of products of an online retailer;
coordinating a first display on electronic devices of a plurality of users of the plurality of products for manual categorization by the plurality of users;
receiving first manual categorizations of the plurality of products from the plurality of users;
preparing a machine learning model for automatically categorizing additional products using the one or more processing modules and based on the first manual categorizations of the plurality of products by the plurality of users;
receiving a product description for a first additional product for a second display of a first webpage of the online retailer;
automatically categorizing the first additional product into one or more categories for the second display of the first webpage of the online retailer based on the product description of the first additional product using the machine learning model and the one or more processing modules; and
coordinating the second display of the first webpage of the online retailer of the first additional product according to the one or more categories of the first additional product as automatically categorized by the one or more processing modules using the machine learning model.

2. The system of claim 1, wherein the plurality of users comprises a plurality of internal users and one or more third party users, wherein the plurality of internal users comprise employees of the online retailer and the one or more third party users comprise one or more external users who are not employees of the online retailer.

3. The system of claim 2, wherein the one or more non-transitory storage modules storing computing instructions are configured to run on the one or more processing modules and perform further acts of:
determining a categorization quality of each of the plurality of internal users and the one or more third party users by comparing one or more manual categorizations of the plurality of products made by each of the plurality of internal users and the one or more third party users to one or more manual categorizations of the plurality of products made by a domain expert;
ranking each of the plurality of internal users and the one or more third party users into rankings by the categorization quality of each of the plurality of internal users and the one or more third party users, wherein each third party user of the one or more third party users is ranked as an individual user in the rankings and each user of the plurality of internal users is ranked as a different individual user in the rankings; and
excluding the first manual categorizations by at least one of the plurality of internal users or the one or more third party users from data used to create the machine learning model if the at least one of the plurality of internal users or the one or more third party users does not meet a predetermined ranking requirement.

4. The system of claim 3, wherein:
determining the categorization quality of each of the plurality of internal users and the one or more third party users comprises determining the categorization quality of each of the plurality of internal users and the one or more third party users by a plurality of attributes of the plurality of products by comparing the one or more manual categorizations of the plurality of products made by each of the plurality of internal users and the one or more third party users to the one or more manual categorizations of the plurality of products made by a domain expert;
ranking each of the plurality of internal users and the one or more third party users comprises ranking each of the plurality of internal users and the one or more third party users by the categorization quality of the plurality of attributes of the plurality of products of each of the plurality of internal users and the one or more third party users; and
excluding the first manual categorizations by the at least one of the plurality of internal users or the one or more third party users from the data used to create the machine learning model comprises excluding the first manual categorizations by the at least one of the plurality of internal users or the one or more third party users from the data used to create the machine learning model for one or more attributes of the first additional product when the at least one of the plurality of internal users or the one or more third party users does not meet a predetermined ranking requirement for categorizing the plurality of products according to one or more attributes of the plurality of attributes of the plurality of products corresponding to the one or more attributes of the first additional product.

5. The system of claim 2, wherein the one or more non-transitory storage modules storing computing instructions are configured to run on the one or more processing modules and perform further acts of:
determining a categorization quality of each of the plurality of internal users and the one or more third party users by comparing one or more manual categorizations of the plurality of products made by each of the plurality of internal users and the one or more third party users to one or more manual categorizations of the plurality of products made by a domain expert;
ranking each of the plurality of internal users and the one or more third party users into rankings by the categorization quality of each of the plurality of internal users and the one or more third party users, wherein each third party user of the one or more third party users is ranked as an individual user in the rankings and each user of the plurality of internal users is ranked as a different individual user in the rankings;
coordinating a third display on the electronic devices of the plurality of users of a second additional product for second manual categorizations by the plurality of users;
receiving the second manual categorizations of the second additional product from the plurality of users;
automatically categorizing the second additional product according to the second manual categorizations of the second additional product by one or more higher ranked users of the plurality of internal users and the one or more third party users when the second manual categorizations of the second additional product by the one or more higher ranked users of the plurality of internal users and the one or more third party users conflicts with the second manual categorizations of the second additional product by one or more lower ranked users of the plurality of internal users and the one or more third party users, wherein the one or more lower ranked users are ranked lower than the one or more higher ranked users according to the categorization quality of each of the plurality of internal users and the one or more third party users; and
coordinating a fourth display of the second additional product on a second webpage of the online retailer as manually categorized by the one or more higher ranked users.

6. The system of claim 1, wherein the one or more non-transitory storage modules storing computing instructions are configured to run on the one or more processing modules and perform further acts of:
automatically categorizing a third additional product into at least one category based on a product description of the third additional product using the machine learning model and the one or more processing modules;
coordinating a fifth display on the electronic devices of the plurality of users of the at least one category for the third additional product for validation by the plurality of users when the at least one category for the third additional product as automatically categorized by the machine learning model is below a predetermined confidence level;
receiving validations of the at least one category for the third additional product from the plurality of users; and
coordinating a sixth display of a third webpage of the online retailer of the third additional product according to the validations of the at least one category for the third additional product from the plurality of users.

7. The system of claim 1, wherein the one or more non-transitory storage modules storing computing instructions are configured to run on the one or more processing modules and perform further acts of:
preparing, with the one or more processing modules, a plurality of categorization rules based on the first manual categorizations of the plurality of products by the plurality of users; and
automatically categorizing, with the one or more processing modules, a fourth additional product using at least one of the plurality of categorization rules.

8. The system of claim 1, wherein:
the plurality of users comprises a plurality of internal users and one or more third party users, wherein the plurality of internal users comprise employees of the online retailer and the one or more third party users comprise one or more external users who are not employees of the online retailer;
the one or more non-transitory storage modules storing computing instructions are configured to run on the one or more processing modules and perform further acts of:
determining a categorization quality of each of the plurality of internal users and the one or more third party users by comparing one or more manual categorizations of the plurality of products made by each of the plurality of internal users and the one or more third party users to one or more manual categorizations of the plurality of products made by a domain expert;
ranking each of the plurality of internal users and the one or more third party users into rankings by the categorization quality of each of the plurality of internal users and the one or more third party users, wherein each third party user of the one or more third party users is ranked as an individual user in the rankings and each user of the plurality of internal users is ranked as a different individual user in the rankings;
coordinating a third display on the electronic devices of the plurality of users of a second additional product for second manual categorizations by the plurality of users;
receiving the second manual categorizations of the second additional product from the plurality of users;
automatically categorizing the second additional product according to the second manual categorizations of the second additional product by one or more higher ranked users of the plurality of internal users and the one or more third party users when the second manual categorizations of the second additional product by the one or more higher ranked users of the plurality of internal users and the one or more third party users conflicts with the second manual categorizations of the second additional product by one or more lower ranked users of the plurality of internal users and the one or more third party users, wherein the one or more lower ranked users are ranked lower than the one or more higher ranked users according to the categorization quality of each of the plurality of internal users and the one or more third party users;
coordinating a fourth display of the second additional product on a second webpage of the online retailer as manually categorized by the one or more higher ranked users;
automatically categorizing a third additional product into at least one category based on a product description of the third additional product using the machine learning model and the one or more processing modules;
coordinating a fifth display on the electronic devices of the plurality of users of the at least one category for the third additional product for validation by the plurality of users when the at least one category for the third additional product as automatically categorized by the machine learning model is below a predetermined confidence level;
receiving validations of the at least one category for the third additional product from the plurality of users;
coordinating a sixth display of a third webpage of the online retailer of the third additional product according to the validations of the at least one category for the third additional product from the plurality of users;
preparing, with the one or more processing modules, a plurality of categorization rules based on the first manual categorizations of the plurality of products by the plurality of users; and
automatically categorizing, with the one or more processing modules, a fourth additional product using at least one of the plurality of categorization rules.

9. A method comprising:
selecting a plurality of products of an online retailer;
coordinating a first display on electronic devices of a plurality of users of the plurality of products for manual categorization by the plurality of users;
receiving first manual categorizations of the plurality of products from the plurality of users;
preparing a machine learning model for automatically categorizing additional products using one or more processing modules and based on the first manual categorizations of the plurality of products by the plurality of users;
receiving a product description for a first additional product for a second display of a first webpage of the online retailer;
automatically categorizing the first additional product into one or more categories for the second display of the first webpage of the online retailer based on the product description of the first additional product using the machine learning model and the one or more processing modules; and
coordinating the second display of the first webpage of the online retailer of the first additional product according to the one or more categories of the first additional product as automatically categorized by the one or more processing modules using the machine learning model.

10. The method of claim 9, wherein the plurality of users comprises a plurality of internal users and one or more third party users, wherein the plurality of internal users comprise employees of the online retailer and the one or more third party users comprise one or more external users who are not employees of the online retailer.

11. The method of claim 10, further comprising:
determining a categorization quality of each of the plurality of internal users and the one or more third party users by comparing one or more manual categorizations of the plurality of products made by each of the plurality of internal users and the one or more third party users to one or more manual categorizations of the plurality of products made by a domain expert;
ranking each of the plurality of internal users and the one or more third party users into rankings by the categorization quality of each of the plurality of internal users and the one or more third party users, wherein each third party user of the one or more third party users is ranked as an individual user in the rankings and each user of the plurality of internal users is ranked as a different individual user in the rankings; and
excluding the first manual categorizations by at least one of the plurality of internal users or the one or more third party users from data used to create the machine learning model if the at least one of the plurality of internal users or the one or more third party users does not meet a predetermined ranking requirement.

12. The method of claim 11, wherein:
determining the categorization quality of each of the plurality of internal users and the one or more third party users comprises determining the categorization quality of each of the plurality of internal users and the one or more third party users by a plurality of attributes of the plurality of products by comparing the one or more manual categorizations of the plurality of products made by each of the plurality of internal users and the one or more third party users to the one or more manual categorizations of the plurality of products made by a domain expert;
ranking each of the plurality of internal users and the one or more third party users comprises ranking each of the plurality of internal users and the one or more third party users by the categorization quality of the plurality of attributes of the plurality of products of each of the plurality of internal users and the one or more third party users; and
excluding the first manual categorizations by the at least one of the plurality of internal users or the one or more third party users from the data used to create the machine learning model comprises excluding the first manual categorizations by the at least one of the plurality of internal users or the one or more third party users from the data used to create the machine learning model for one or more attributes of the first additional product when the at least one of the plurality of internal users or the one or more third party users does not meet a predetermined ranking requirement for categorizing the plurality of products according to one or more attributes of the plurality of attributes of the plurality of products corresponding to the one or more attributes of the first additional product.

13. The method of claim 10, further comprising:
determining a categorization quality of each of the plurality of internal users and the one or more third party users by comparing one or more manual categorizations of the plurality of products made by each of the plurality of internal users and the one or more third party users to one or more manual categorizations of the plurality of products made by a domain expert;
ranking each of the plurality of internal users and the one or more third party users into rankings by the categorization quality of each of the plurality of internal users and the one or more third party users, wherein each third party user of the one or more third party users is ranked as an individual user in the rankings and each user of the plurality of internal users is ranked as a different individual user in the rankings;
coordinating a third display on the electronic devices of the plurality of users of a second additional product for second manual categorizations by the plurality of users;
receiving the second manual categorizations of the second additional product from the plurality of users;
automatically categorizing the second additional product according to the second manual categorizations of the second additional product by one or more higher ranked users of the plurality of internal users and the one or more third party users when the second manual categorizations of the second additional product by the one or more higher ranked users of the plurality of internal users and the one or more third party users conflicts with the second manual categorizations of the second additional product by one or more lower ranked users of the plurality of internal users and the one or more third party users, wherein the one or more lower ranked users are ranked lower than the one or more higher ranked users according to the categorization quality of each of the plurality of internal users and the one or more third party users; and
coordinating a fourth display of the second additional product on a second webpage of the online retailer as manually categorized by the one or more higher ranked users.

14. The method of claim 9, further comprising:
automatically categorizing a third additional product into at least one category based on a product description of the third additional product using the machine learning model and the one or more processing modules;
coordinating a fifth display on the electronic devices of the plurality of users of the at least one category for the third additional product for validation by the plurality of users when the at least one category for the third additional product as automatically categorized by the machine learning model is below a predetermined confidence level;
receiving validations of the at least one category for the third additional product from the plurality of users; and
coordinating a sixth display of a third webpage of the online retailer of the third additional product according to the validations of the at least one category for the third additional product from the plurality of users.

15. The method of claim 9, further comprising:
preparing, with the one or more processing modules, a plurality of categorization rules based on the first manual categorizations of the plurality of products by the plurality of users; and
automatically categorizing, with the one or more processing modules, a fourth additional product using at least one of the plurality of categorization rules.

16. The method of claim 9, wherein:
the plurality of users comprises a plurality of internal users and one or more third party users, wherein the plurality of internal users comprise employees of the online retailer and the one or more third party users comprise one or more external users who are not employees of the online retailer;
the method further comprises:
determining a categorization quality of each of the plurality of internal users and the one or more third party users by comparing one or more manual categorizations of the plurality of products made by each of the plurality of internal users and the one or more third party users to one or more manual categorizations of the plurality of products made by a domain expert;
ranking each of the plurality of internal users and the one or more third party users into rankings by the categorization quality of each of the plurality of internal users and the one or more third party users, wherein each third party user of the one or more third party users is ranked as an individual user in the rankings and each user of the plurality of internal users is ranked as a different individual user in the rankings;
coordinating a third display on the electronic devices of the plurality of users of a second additional product for second manual categorizations by the plurality of users;
receiving the second manual categorizations of the second additional product from the plurality of users;
automatically categorizing the second additional product according to the second manual categorizations of the second additional product by one or more higher ranked users of the plurality of internal users and the one or more third party users when the second manual categorizations of the second additional product by the one or more higher ranked users of the plurality of internal users and the one or more third party users conflicts with the second manual categorizations of the second additional product by one or more lower ranked users of the plurality of internal users and the one or more third party users, wherein the one or more lower ranked users are ranked lower than the one or more higher ranked users according to the categorization quality of each of the plurality of internal users and the one or more third party users;
coordinating a fourth display of the second additional product on a second webpage of the online retailer as manually categorized by the one or more higher ranked users;
automatically categorizing a third additional product into at least one category based on a product description of the third additional product using the machine learning model and the one or more processing modules;
coordinating a fifth display on the electronic devices of the plurality of users of the at least one category for the third additional product for validation by the plurality of users when the at least one category for the third additional product as automatically categorized by the machine learning model is below a predetermined confidence level;
receiving validations of the at least one category for the third additional product from the plurality of users;
coordinating a sixth display of a third webpage of the online retailer of the third additional product according to the validations of the at least one category for the third additional product from the plurality of users;
preparing, with the one or more processing modules, a plurality of categorization rules based on the first manual categorizations of the plurality of products by the plurality of users; and
automatically categorizing, with the one or more processing modules, a fourth additional product using at least one of the plurality of categorization rules.

17. A system comprising:
one or more processing modules; and
one or more non-transitory storage modules storing computing instructions configured to run on the one or more processing modules and perform acts of:
selecting a plurality of products of an online retailer;
coordinating a first display on electronic devices of a plurality of users of the plurality of products for first manual categorizations by the plurality of users;
receiving the first manual categorizations of the plurality of products from the plurality of users;
preparing, with the one or more processing modules, a plurality of categorization rules based on the first manual categorizations of the plurality of products by the plurality of users;
automatically categorizing, with the one or more processing modules, a first additional product using at least one of the plurality of categorization rules; and
coordinating a second display of a first webpage of the online retailer of the first additional product as automatically categorized by the one or more processing modules according to the plurality of categorization rules.

18. The system of claim 17, wherein the one or more non-transitory storage modules storing computing instructions are configured to run on the one or more processing modules and perform further acts of:
determining a categorization quality of each of the plurality of users by comparing one or more manual categorizations of the plurality of products made by each of the plurality of users to one or more manual categorizations of the plurality of products made by a domain expert;
ranking each of the plurality of users by their respective categorization quality;
coordinating a third display on the electronic devices of the plurality of users of a second additional product for third manual categorizations by the plurality of users;
receiving the third manual categorizations of the second additional product from the plurality of users;
automatically categorizing the second additional product according to the third manual categorizations of the second additional product by one or more higher ranked users of the plurality of users when the third manual categorizations of the second additional product by the one or more higher ranked users of the plurality of users conflicts with the third manual categorizations of the second additional product by one or more lower ranked users of the one or more of the plurality of users, wherein the one or more lower ranked users are ranked lower than the one or more higher ranked users according to the categorization quality of each of the plurality of users; and
coordinating a fourth display of the second additional product on a second webpage of the online retailer as manually categorized by the one or more higher ranked users.

19. The system of claim 17, wherein the one or more non-transitory storage modules storing computing instructions are configured to run on the one or more processing modules and perform further acts of:
preparing a machine learning model for automatically categorizing additional products using the one or more processing modules and based on the first manual categorizations of the plurality of products by the plurality of users;
receiving a product description for a third additional product for a fifth display of a third webpage of the online retailer;
automatically categorizing the third additional product into one or more categories for the fifth display of the third webpage of the online retailer based on the product description of the third additional product using the machine learning model and the one or more processing modules; and
coordinating the fifth display of the third webpage of the online retailer of the third additional product according to the one or more categories of the third additional product as automatically categorized by the one or more processing modules using the machine learning model.

20. The system of claim 19, wherein the one or more non-transitory storage modules storing computing instructions are configured to run on the one or more processing modules and perform further acts of:
determining a categorization quality of each of the plurality of users by comparing one or more manually categorizations of the plurality of products made by each of the plurality of users to one or more manually categorizations of the plurality of products made by a domain expert;
ranking each of the plurality of users by their respective categorization quality; and
excluding the first manual categorizations by at least one user of the plurality of users from data used to create the machine learning model if the at least one user of the plurality of users does not meet a predetermined ranking requirement.

21. The system of claim 19, wherein the one or more non-transitory storage modules storing computing instructions are configured to run on the one or more processing modules and perform further acts of:
automatically categorizing a fourth additional product into at least one category based on a product description of the fourth additional product using the machine learning model and the one or more processing modules;
coordinating a sixth display on the electronic devices of the plurality of users of the at least one category for the fourth additional product for validation by the plurality of users;
receiving validations of the at least one category for the fourth additional product from the plurality of users; and
coordinating a seventh display of a fourth webpage of the online retailer of the fourth additional product according to the validations of the at least one category for the fourth additional product from the plurality of users.
